(19) United States
(12) Patent Application Publication
(10) Pub. No.: US 2025/0139811 A1
(43) Pub. Date: May 1, 2025

(54) METHOD OF CONTROLLING THE OBSERVATION OF A SPACE USING A TRACKING SYSTEM AND ASSOCIATED DEVICE

(71) Applicants: THALES, MEUDON (FR); UNIVERSITE PARIS-SACLAY, GIF SUR YVETTE FRANCE (FR); CENTRE NATIONAL DE LA RECHERCHE SCIENTIFIQUE, PARIS (FR)

(72) Inventors: Nicolas ATIENZA, PALAISEAU CEDEX (FR); Christophe LABREUCHE, PALAISEAU CEDEX (FR); Martine SEBAG, VILLEJUIF (FR); Johanne COHEN, ORSAY (FR); Nicolas HONORE, RUNGIS (FR)

(21) Appl. No.: 18/931,810

(22) Filed: Oct. 30, 2024

(30) Foreign Application Priority Data
Oct. 31, 2023 (FR) 2311852

(51) Int. Cl. G06T 7/70

(52) U.S. Cl. CPC G06T 7/70; G06T 2207/20081; G06T 2207/20084

(57) ABSTRACT

A method of monitoring observation uses a space tracking system. The method is implemented by a control module which is part of the tracking system. The method includes: a step of thumbnail training, each thumbnail gathering a set of data accessible to the tracking system over a respective zone and a predefined time interval, the zones associated with each thumbnail covering the space observed by the tracking system and the set of predefined time intervals covering an observation time interval, the data including at least: a step of monitoring the observation using a space tracking system corresponding to at least one thumbnail by applying a control function to all the data of the at least one thumbnail.

The present invention relates to a method of controlling the observation of a space using a system for tracking. The invention further relates to a control module and associated tracking system.

The proposed invention belongs to the field of air traffic control.

Airspace control is ensured by monitoring all aircraft. Thereof means supervising air traffic to prevent collisions between aircraft and controlling the traffic, both in cruise flight and around airports—take-off and landing.

To implement such control, air traffic controllers use an air traffic surveillance system based on aircraft tracking, called a tracking system. The tracking system is apt to estimate in real-time from data coming from sensors, the best possible estimation of the position, of the heading and of the velocity of each aircraft in a given flight information region.

The Flight Information Region is often referred to by the acronym FIR.

All the estimated data form a track.

The quality of the estimation of the track (tracking) varies depending on the parameter setting of the tracking system, the quality of the data acquired by the sensors or else on environmental data such as the topology of a terrain or the weather.

As such, it is desirable for an air traffic controller to know the quality of the estimation of the tracks reconstructed by the tracking system.

To this end, it is known to use the requirements of the ESASSP standard, which is presented in detail in the document entitled “EUROCONTROL Specification for ATM Surveillance System Performance” (Volume 1), ISBN 978-2-87497-022-1 and which was published in March 2012.

More specifically, a set of requirements defined by the ESASSP standard is evaluated by comparing the outputs of the tracking system with an estimation of the ideal trajectory of the aircraft.

The ideal trajectory is thus a reconstructed trajectory that can only be computed offline.

For this reason, such an evaluation only provides a posteriori evaluation of the quality of the track evaluation by the FIR tracking system.

There is hence a need for a method for evaluating the quality of the tracking performed by a tracking system.

To this end, the description describes a method of controlling the observation using a space tracking system, the method being implemented by a control module which is part of the tracking system, the controlling method including:
a step of thumbnail training, each thumbnail gathering a set of data accessible to the tracking system over a respective zone and a predefined time interval, the zones associated with each thumbnail covering the space observed by the tracking system and the set of predefined time intervals covering an observation time interval, the data including at least sensor data, and
a step of controlling the observation using a space tracking system corresponding to at least one thumbnail by applying a control function to all the data of the at least one thumbnail.

According to particular embodiments, the control method has one or a plurality of the following features, taken individually or according to all technically possible combinations:
all the data of each thumbnail comprise a reconstructed trajectory.
the tracking system outputs computed data, all the data of each thumbnail comprising the computed data.
the control function is a function for detecting the possible presence of an anomaly in the thumbnail.
the anomaly detection function is obtained by a learning procedure, the learning procedure including:
   learning a vector representation of thumbnails, and
   obtaining an anomaly detection function from the learned vector representation.
the learning step comprises the learning of a first sub-function from a labeled data set so as to obtain a first learned sub-function suitable for implementing a pretext task, the first learned sub-function being a neural network including a plurality of layers of neurons, the vector representation being the penultimate layer of the first learned sub-function.
the first sub-function is a residual neural network.
the obtaining step is implemented using single-class support vector machines.
the obtaining step is implemented using a neural network suitable for measuring the distance from one thumbnail to a set of thumbnails which are considered to be normal.
the control method includes a step of identification of a possible cause of the presence of an anomaly by applying an identification function to the label or labels wherein the presence of an anomaly was detected during the implementation step, the identification step being carried out by the anomaly correction module.
the control method includes a test of a corrective action associated with the identified cause.
the tracking system is apt to collect data coming from a plurality of sensors, the cause being a failure of a sensor and the corrective action being the removal of the data from the sensor presenting the failure.
the identification step comprises:
   the generation of thumbnails corresponding to data accessible to a plurality of subsets of distinct sensors,
   the detection of anomalies in the thumbnails generated by the implementation of the detection method, and
   the deduction of the sensor(s) causing the anomaly.
the control function is a function for computing the performance of the tracking system.

The description further describes a module for controlling the observation of a space by a tracking system, the control module being apt to:
form thumbnails, each thumbnail gathering a set of data accessible to the tracking system over a respective zone and a predefined time interval, the zones associated with each thumbnail covering the space observed by the tracking system and the set of predefined time intervals covering an observation time interval, the data including at least sensor data, and
controlling the observation using a space tracking system corresponding to at least one thumbnail by applying a control function to all the data of the at least one thumbnail.

The description further proposes a tracking system equipped with a control module as described hereinabove.

In the present description, the expression “suitable for” means equally well “apt to” or “configured for”.

The features and advantages of the invention will appear upon reading the following description, given only as an example, but not limited to, and making reference to the enclosed drawings, wherein:

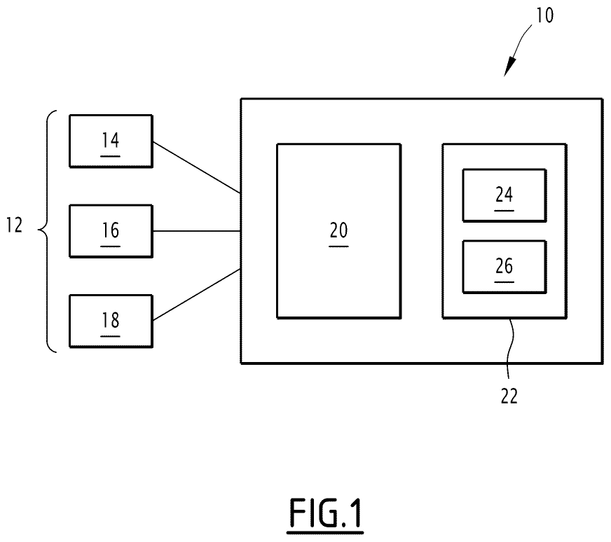

FIG. 1 is a schematic representation of an example of a tracking system in interaction with a set of sensors,

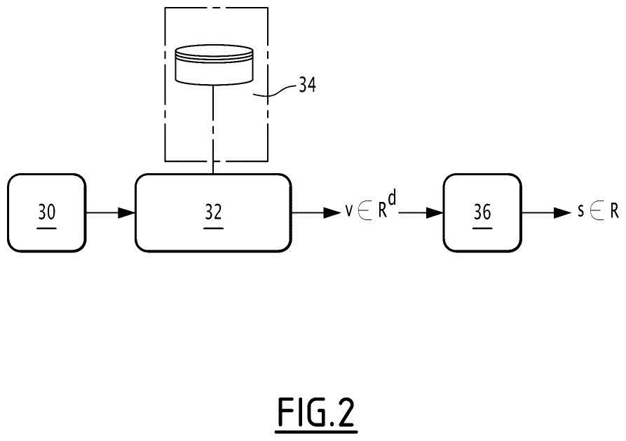

FIG. 2 is a block diagram of an example of a method for detecting anomalies in a space observed by the tracking system,

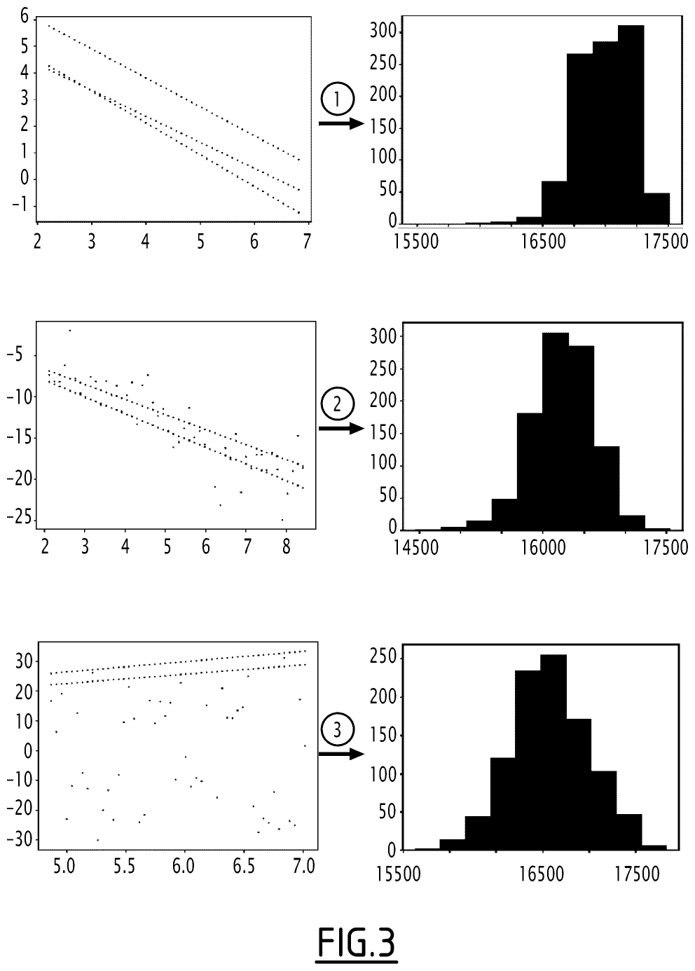

FIG. 3 is a schematic representation of the simulations of implementation of the method for detecting anomalies according to FIG. 2, and

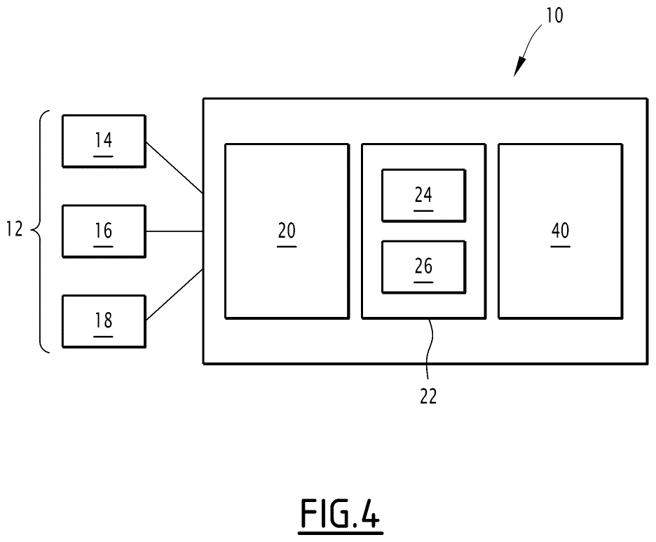

FIG. 4 is a schematic representation of an example of tracking system in interaction with a set of sensors,

FIG. 1 diagrammatically illustrates a tracking system 10 in interaction with a set 12 of sensors.

The tracking system 10 is apt to observe an airspace in order to determine the trajectories of the aircraft passing through an observed space.

Thereof makes it possible to carry out air traffic control in the space considered.

For this purpose, the tracking system 10 is suitable for collecting data from all sensors and for analyzing the collected data.

The tracking system 10 outputs computed data.

The velocity, the position and the heading of each aircraft passing through the observed space are examples of computed data.

Advantageously, the tracking system 10 adds to such data, data serving to associate each new computed point with an existing trajectory.

The set 12 of sensors is suitable for obtaining data in the observed space.

According to the example described, the set 12 of sensors comprises an ADS 14 unit, a WAM 16 unit and a radar 18.

ADS 14 is a cooperative surveillance system for air traffic control and other related applications. An aircraft equipped with an ADS 14 unit determines the position thereof by a satellite positioning system (GPS) and periodically sends the position and other information to ground stations.

ADS is the abbreviation of Automatic Dependent Surveillance.

Such an ADS 14 unit is sometimes also called unit-B, ADS-B being the abbreviation of Automatic Dependent Surveillance-Broadcast.

To obtain the location of an aircraft, a WAM 16 unit uses data from a plurality of sensors.

WAM is the abbreviation of Wide Area Multilateration and refers to an aircraft monitoring technology based on the principle of difference in arrival time that is used at an airport.

For example, the WAM 16 unit collects data from a plurality of ground antennas for applying mathematical calculations to obtain the position of the aircraft.

A radar 18 detects the presence of aircraft in the sky and determines the position thereof. The radar 18 emits electromagnetic pulses into the sky, and the detection and location of an aircraft are obtained by analyzing the wave reflected by the aircraft and retransmitted toward the radar 18.

According to the example shown in FIG. 1, the tracking system 10 includes an analysis module 20 and an anomaly detection module 22.

The analysis module 20 is suitable for analyzing the data from sensors to compute new data.

More particularly, the analysis module 20 is apt to predict the trajectory of an aircraft.

Such an analysis module 20 is often referred to as a “tracker”.

For this purpose, the analysis module 20 uses a data fusion technique usually involving a Kalman filter.

The fusion technique depends on parameters representative of the environment, such as sensor noise.

The parameters are set according to the environment usually encountered. For example, if the sensor considered usually has Gaussian noise, parameters corresponding to such noise will be set.

The anomaly detection module 22 is suitable for implementing the steps of a method for detecting anomalies in the observed space.

For this purpose, according to the example proposed, the anomaly detection module 22 includes a training unit 24 and a detection unit 26, the roles of which will appear hereinafter in the description.

An example of implementation of the method for detecting anomalies is now described with reference to FIG. 2.

The anomaly detection method is designed to detect anomalies in the space observed by the tracking system 10.

Herein, detection should be taken in a broad sense as just meaning that a probability of an anomaly existing in a part of the observed space can be determined.

Such a probability will be expressed herein in the form of a normality score which is a value representative of the probability of presence of an anomaly.

An anomaly corresponds to a degradation of the tracking quality by the tracking system 10.

As a result, the normality score can also be interpreted as an evaluation score of the quality of the tracking carried out by the tracking system 10.

The causes of such degradation of the tracking system 10 can be multiple. Thereof can come from a weather problem or an exterior problem such as a very strong thunderstorm, a frozen radome of a radar at altitude, from a solar flare.

It can also be a problem coming from a sensor, such as an O-ring problem on a rotating radar (creates an azimuth offset on the positions sent by the radar) or an abnormal noise problem on the data from a sensor.

The cause of the degradation may be a cyber-attack wherein false sensor data are sent.

According to yet another example, the problem may arise from a malfunction of the analysis module 20.

Of course, degradation may correspond to the presence of several of the aforementioned examples of causes.

The detection method includes a training step and a detection step.

During the thumbnail training step, the detection module 22, and more precisely the training unit 24, forms thumbnails.

Said step is schematically represented, in FIG. 2, by the block 30.

A thumbnail gathers a set of data accessible to the tracking system 10 over a respective zone and a predefined time interval.

The data include at least data coming from one or a plurality of sensors of the set 12 of sensors.

For the continuation, it is assumed that the data in the thumbnail are only the data from the unit ADS 14, the unit WAM 16 and the radar 18, which leads to a rapid gathering of said values.

However, the data set may include other elements.

According to one example, the data set of each thumbnail comprise one or a plurality of reconstructed trajectories.

According to another example, all the data of a thumbnail include the data computed by the tracking system 10.

In a variant, the set of data of a thumbnail include the data from the sensors, the data reconstructed by the tracking system 10 and the data computed by the tracking system 10.

The set of thumbnails covers the observed space in time and space.

Thereby, the zones associated with each thumbnail tile the space observed by the tracking system 10 and the set of predefined time intervals covers an observation time interval.

As an example, but not limited to, the thumbnail may correspond to a zone of a few tens of kilometers and a time interval of one hour.

A thumbnail thereby corresponds to a limited volume of space (cell) over a finite period of time. A thumbnail is thus a spatially and temporally local view of the data from the sensors and possibly of the tracking performed by the tracking system 10.

It is also possible to limit a thumbnail to a two-dimensional space insofar as the aircraft fly at altitudes set by the air corridors.

In such a case, only latitude and longitude are taken into account.

At the end of the training step, the training unit 24 thereby has a set of thumbnails.

During the detection step, the detection module 22 detects the possible presence of anomalies in the thumbnail.

To this end, the detection unit 26 of the detection module 22 applies an anomaly detection function to all the data of the thumbnail.

Such an anomaly detection function is shown schematically in FIG. 2.

The anomaly detection function is obtained by a learning procedure.

The learning procedure comprises a step of learning a vector representation of the thumbnails.

In such context, a vector representation corresponds to the projection of elements of [symbol] ^{n×m×c} (space of images with c colors, n pixels in the length thereof and m pixels in the width thereof) into a space of [symbol] ^{d} (vector space of dimension d).

Such a representation makes it possible to reduce the number of variables needed to express the information and to be able to manipulate the data as vectors giving access to mathematical tools known as distance calculation. A simplified implementation results therefrom. The function giving the representation corresponds to the block 32 in FIG. 2 and the learning is schematically represented by the part 34 in FIG. 2.

The learning step herein consists in learning a first sub-function which is a neural network.

The neural network includes an ordered succession of neuron layers, each of which takes the inputs thereof from the outputs of the preceding layer.

More precisely, each layer comprises neurons taking the inputs thereof from the outputs of the neurons of the preceding layer, or from the input variables for the first layer.

In a variant, more complex neural network structures can be envisaged with a layer which can be connected to a layer farther away than the immediately preceding layer.

Each neuron is also associated with an operation, i.e. a type of treatment, to be performed by said neuron within the corresponding processing layer.

Each layer is linked to the other layers by a plurality of synapses. A synaptic weight is associated with each synapse, and each synapse forms a link between two neurons. Same is often a real number that can take positive as well as negative values. In certain cases, synaptic weight is a complex number.

Each neuron is apt to perform a weighted sum of the value(s) received from the neurons of the preceding layer, each value then being multiplied by the respective synaptic weight of each synapse, or link between said neuron and the neurons of the preceding layer, then to apply an activation function, typically a non-linear function, to said weighted sum, and to deliver at the output of said neuron, more particularly to the neurons of the next layer which are connected thereto, the value resulting from the application of the activation function. The activation function is used for introducing a non-linearity in the processing performed by each neuron. The sigmoid function, the hyperbolic tangent function, the Heaviside function are examples of activation functions.

As an optional addition, each neuron is also apt to apply, in addition, a multiplicative factor, also called bias, to the output of the activation function, and the value delivered at the output of said neuron is then the product of the bias value and of the value derived from the activation function.

As a specific example, the first sub-function is herein a residual neural network.

A residual neural network is a neural network wherein at least one neuron in one layer interacts with a neuron in a non-neighboring layer.

Such a network is often referred to as ResNet.

In the present case, the learning of the first sub-function is implemented from a labeled data set in order to obtain a first learned sub-function suitable for implementing a predefined task.

The vector representation is then the penultimate layer of the first learned sub-function.

Thereby, a predefined task is used that has no connection with the task of determining the presence of anomalies. The predefined task serves only for the learning of the free parameters of the neural network that are defined through the learning operation. In this sense, the predefined task can be qualified as a pretext task, a name which will be used hereinafter.

In this sense, it can be considered that the training on the pretext task is a pre-training serving to obtain pre-trained weights.

In the example described, the first sub-function was trained in a classification task.

Typically, the first sub-function is trained to recognize one or a plurality of elements in an annotated database such as an ImageNet image database.

According to a first example corresponding to an unsupervised framework, the weights of the first sub-function thereby pre-trained are preserved as such.

According to a second example corresponding to a supervised framework, the weights of the first sub-function thereby pre-trained are refined by learning on a specialization task.

In the present case, a specialization task is a task specific to the field of air traffic control.

What has just been described can be formulated more formally as follows.

The first sub-function is a neural network according to the ResNet architecture which is the composition of k linear operations parameterized by the neural learning weights Θ=(Wᵢ, bᵢ) as well as k non-linear operations ψᵢ (activation function).

One thereby has:

$$∀ i \leq k , {f}_{i} ( {z}_{i - 1} ) = {ψ}_{i} ( {W}_{i} {z}_{i - 1} + {b}_{i} + {z}_{i - 2} ) \\ y = {Ψ}_{Θ} ( x ) = {f}_{k} ° … ° {f}_{i} ° … ° {f}_{1} ( x )$$

Where:
i is an integer
fᵢ is a parameterized linear operation,
zᵢ₋₁ is the vector of neurons of the layer i−1,
Wᵢ is the weight matrix of the linear operation of the layer i,
Θ=((Wᵢ, bᵢ)_{i=1, . . . , k})
bᵢ is the bias of the linear operation of layer i,
y is the output of the neural network, and
Ψ_{Θ} is the parameterized function Θ formed by the neural network, and
∘ means the mathematical operation of composition.

The first sub-function is trained on a classification task by means of a dataset labeled D={(xᵢ, yᵢ)ᵢ} by minimizing a criterion.

The criterion chosen is e.g. the following:

$$Θ = {min}_{θ} {\sum }_{( x , y ) ∈ D} L ( y ; {Ψ}_{θ} ( x ) )$$

where L is a cost function for estimating the distance between the predicted class and the labeled class.

The criterion is minimized by updating the weights at each iteration, by backpropagation.

As mentioned hereinabove, once such task has been learned, the vector representation of an image is obtained by removing the last layer of the network and by freezing the weights of the network.

By noting V the vector representation operator of a thumbnail x, with the previous notations, one obtains:

$$V : {R}^{n \times n} \to {R}^{d} \\ x ↦ {V}_{θ} ( x ) = {f}_{k - 1} ° … ° {f}_{i} ° … ° {f}_{1} ( x )$$

d is herein a parameter that may vary. For example, a value of 2048 was used by the Applicant.

The learning procedure also comprises a step of obtaining an anomaly detection function from the learned vector representation.

The detection function is suitable for providing a normality score from the vector representation of a thumbnail.

During the obtaining step, the anomaly detection function is learned by a learning technique.

According to a first example of implementation, a second sub-function is trained on the vector representation of a subset of thumbnails without any anomaly.

According to the example of FIG. 2, the second sub-function is a single-class support vector machine and corresponds to block 36.

Such an element is more often referred to as “One-class SVM” referring to the corresponding English name of “One-class Support-Vector Machine”.

A specific example of a technique for obtaining a normality score is now described.

Such technique seeks to project the observed points into a space of greater dimension and to find a hypershere that contains almost all the points. The points inside the sphere are considered normal and the points outside the sphere are considered anomalies.

The representation corresponding to the projector image ϕ and the hypershere are obtained by solving the following optimization problem:

$${min}_{r ∈ R , ξ ∈ {R}^{d} , c ∈ F} {r}^{2} + \frac{1}{vd} {\sum }_{i} {ξ}_{i} \\ s . c . ∀ x ∈ D , i \leq n , {‖ ϕ ( {V}_{θ} ( x ) ) - c ‖}^{2} \leq {r}^{2} + {ξ}_{i} , {ξ}_{i} \geq 0$$

Where:
ϕ: R^{d}→F is the projection application (projector). d is the dimension of the input space (in our case, the dimension of the vector representation of the thumbnails V) and F the image of the projector (the dimension thereof is seen as a hyper parameter). It is only imposed that a scalar product of elements of F can be expressed in the form of a kernel over the elements of [symbol] ^{d}.
r is the radius of the hypersphere,
v is a weighting v∈[0,1] considered as a hyper parameter.
s.c. refers to the expression under the constraint of,
c is the position of the center of the hypersphere,
ξ is a relaxation variable of the hypersphere boundary serving to accept points outside the hypersphere but very close to the boundary thereof.

Such problem can be reformulated through the dual Lagrange function, adding in α, β as Lagrange coefficient:

$$g ( α , β ) = {inf}_{r , ξ , c} L ( r , ξ , c , α , β ) = {inf}_{r , ξ , c} {r}^{2} + {\sum }_{i} {α}_{i} \{ {‖ ϕ ( {x}_{i} ) - c ‖}^{2} - {r}^{2} - {ξ}_{i} \} + \frac{1}{vd} {\sum }_{i} {ξ}_{i} - {\sum }_{i} {β}_{i} {ξ}_{i}$$

By deriving with respect to the parameters, the following three relations are obtained:

$$\frac{\partial L}{\partial r} = 2 r ( 1 - {\sum }_{i} α i ) = 0 ⇒ {\sum }_{i} α i = 1 \\ \frac{\partial L}{\partial {ξ}_{i}} = \frac{1}{vl} - {α}_{i} - {β}_{i} = 0 ⇒ 0 \leq {α}_{i} \leq \frac{1}{vd} \\ \frac{\partial L}{\partial c} = - 2 {\sum }_{i} {α}_{i} ( Φ ( {x}_{i} ) - c ) = 0 ⇒ c = {\sum }_{i} {α}_{i} Φ ( {x}_{i} )$$

Thereby, Lagrange's dual function is written:

$$g ( α , β ) = {\sum }_{i} {α}_{i} {‖ Φ ( {x}_{i} ) - {\sum }_{j} {α}_{j} Φ ( {x}_{j} ) ‖}^{2} si 0 \leq {α}_{i} \leq \frac{1}{vd} et {\sum }_{i} {α}_{i} = 1 - ∞ otherwise$$

The dual problem is then written:

$${max}_{α} {\sum }_{i} {α}_{i} 〈 Φ ( {x}_{i} ) \vert Φ ( {x}_{i} ) 〉 - {\sum }_{i , j} {α}_{i} {α}_{j} 〈 Φ ( {x}_{i} ) \vert Φ ( {x}_{j} ) 〉 s . c . {\sum }_{i} {α}_{i} = 1 et 0 \leq {α}_{i} \leq \frac{1}{vd}$$

A normality score can then easily be calculated from the decision function f written as:

$$f ( Φ ( x ) ) = {r}^{2} + 2 {\sum }_{i} {α}_{i} 〈 Φ ( {x}_{i} ) \vert Φ ( x ) ) 〉 - 〈 Φ ( x ) \vert Φ ( x ) ) 〉 - {\sum }_{i , j} {α}_{i} {α}_{j} 〈 Φ ( {x}_{i} ) \vert Φ ( {x}_{j} ) 〉$$

The decision function is the function defined by f. Same identifies anomalies (more often referred to as “outliers”): The points with the highest values are considered anomalies. The function can be normalized between 0 and 1 to make the interpretation thereof more intuitive.

Such a first example corresponds to an unsupervised learning technique.

In fact, from a database assumed to be normal (without anomalies), a detection function is derived that will evaluate for a new thumbnail whether the thumbnail resembles or differs from same already observed.

According to a second example of implementation of the obtaining step, the obtaining step is implemented using a neural network suitable for measuring the distance from a thumbnail to a set of thumbnails considered to be normal.

Such a set of thumbnails can be obtained by evaluating ESASSP criteria or by a manual annotation performed by an expert.

As an illustration, the detection function gives at the output a normality score which corresponds to the projection value of the vector representation of the thumbnails in a learned space.

The learned space can be obtained by a contrastive approach, i.e. by comparing examples sharing certain properties (so-called positive examples) with a set of examples that do not share said properties (so-called negative examples).

The normality score is then defined as the inverse of the distance from the center of a set of thumbnails considered by an expert to be free of anomalies.

In such a second example, the learning technique is semi-supervised because of the initial provision of the set of thumbnails considered to be normal.

The results obtained by implementing the method described in a simulation are now illustrated with reference to FIG. 3.

For this purpose, three sets of synthetic data corresponding to cases 1, 2 and 3 in FIG. 3 are used.

Case 1 corresponds to a data set simulating data corresponding to realistic data coming from the three sensors. In this sense, the data set of case 1 corresponds to a normal data set.

The functions used for data generation are:

$$∀ i \leq n \{ \begin{matrix}( {y}_{i}^{( 1 )} ( x ) = 1.1 \times ( {a}_{i} \times {s}_{i} ) x + 1.1 \times {b}_{i} \\ {y}_{i}^{( 2 )} ( x ) = ( {a}_{i} \times {s}_{i} ) x + 1.3 \times {b}_{i} \\ {y}_{i}^{( 3 )} ( x ) = 0.899 \times ( {a}_{i} \times {s}_{i} ) x + {b}_{i}\end{matrix}$$

Where:
i is the index of a point in the dataset,
n is the number of points in the dataset,
yᵢ⁽¹⁾(x) refers to the type 1 ordinate of point i of the dataset
sᵢ˜ [symbol] ([−1,1]) meaning that the variable sᵢ follows a uniform distribution the values of which are comprised between −1 and 1,
aᵢ˜ [symbol] ([−1,4]) meaning that the variable aᵢ follows a uniform distribution the values of which are comprised between −1 and 4, and
bᵢ˜ [symbol] (0,5) meaning that the variable bᵢ follows a normal distribution of mean value 0 and of variance 5.

To the left of the arrow marked 1, the corresponding thumbnail is represented.

It appears in the thumbnail that each dataset corresponds to a rectilinear trajectory, each rectilinear trajectory having a similar variation (direction coefficient and ordinate originally similar).

Case 2 corresponds to a data set simulating data corresponding to data where one of the sensors has a much lower signal-to-noise ratio than the other two sensors. It is assumed, however, that the signal coming from the sensor having a reduced signal-to-noise ratio can actually be used. In this sense, the set of data of case 2 corresponds to a set of noisy data.

With the same notations as for case 1, the functions used for the generation of the data are as follows:

$$∀ i \leq n \{ \begin{matrix}{y}_{i}^{( 1 )} ( x ) = ( {a}_{i} \times {s}_{i} ) x + {b}_{i} + 𝒩 ( 0 , 2.5 ) \\ {y}_{i}^{( 2 )} ( x ) = ( {a}_{i} \times {s}_{i} ) x + 1.3 \times {b}_{i} \\ {y}_{i}^{( 3 )} ( x ) = 0.899 \times ( {a}_{i} \times {s}_{i} ) x + {b}_{i}\end{matrix}$$

where [symbol] (0,2.5) refers to a number obtained by using a normal distribution of mean value 0 and of variance 2.5.

Therefore, such a case corresponds to simulating Gaussian noise.

The thumbnail resulting from the simulation of noisy data is represented to the left of the arrow marked 2.

Case 3 corresponds to a data set simulating data corresponding to data where one of the sensors has unusable data. In this sense, the data set of case 3 corresponds to a corrupted data set.

With the same notations as for case 1, the functions used for the generation of the data are as follows:

$$∀ i \leq n \{ \begin{matrix}{y}_{i}^{{}_{( 1 )}} ( x ) = ( ( [ - 1 , 1 ] ) \times ( [ - 1 , 4 ] ) ) x + bi + ( 0 , 5 ) \\ {y}_{i}^{( 2 )} ( x ) = ( {a}_{i} \times {s}_{i} ) x + 1.3 \times {b}_{i} \\ {y}_{i}^{( 3 )} ( x ) = 0.899 \times ( {a}_{i} \times {s}_{i} ) x \times {b}_{i}\end{matrix}$$

Where:
[symbol] ([−11]) refers to a number obtained by using a uniform law the values of which are comprised between −1 and 1,
[symbol] ([−1,4]) refers to a number obtained by using a uniform law the values of which are comprised between −1 and 4, and
where [symbol] (0,2.5) refers to a number obtained by using a normal distribution of mean value 0 and of variance 2.5.

The thumbnail resulting from such simulation of noisy data is represented to the left of the arrow marked 3 in FIG. 3.

The right side of FIG. 3 shows the normality score distributions obtained for all simulated datasets.

The normality scores are the values taken by the decision function. The lowest scores identify the anomalies.

The score distribution is obtained by analyzing the score of each thumbnail, all thumbnails being associated with a respective score.

The comparison of the histograms of cases 2 and 3 with the histogram of case 1 shows the existence of a shift of values to the left.

As a result, it is possible to differentiate case 1 with cases 2 and 3, i.e. to differentiate between normal data and noisy or corrupted data.

A more pronounced shift can also be observed for case 2 compared with case 3. Thereby, histogram analysis makes it possible to differentiate between corrupted data and noisy data, i.e. between unusable data and abnormal but usable data.

Through such example, it has been shown that the method which has just been described thus serves to detect an anomaly with a good efficiency.

The present method uses thumbnails corresponding to a limited volume of space as well as a finite time period. As a result, the method is a local approach in both time and space.

As a result, a finer analysis of the situation can be done. More particularly, the effects are not averaged over an entire FIR, unlike a technique for evaluating criteria of the ESASSP standard.

Such fineness of analysis does not prevent that, if need be, it is possible to provide a global analysis, e.g. by aggregating normality scores.

It could also be noted that the method can be implemented in a totally unsupervised manner. Thereof has a real advantage in the sense that the method can be easily adapted to new situations or new contexts.

For example, the method can be used in contexts other than ATM and in particular in the UTM.

ATM is the abbreviation of Air traffic Management which refers to the management of manned aircraft traffic (generally airliners) while UTM is the abbreviation of Unmanned Aircraft System Traffic Management which refers to the management of drone traffic.

Such independence serves to avoid redefining the functions involved if the use of the tracking system 10 is to evolve.

In this sense, the method is universal in the sense that same can be adapted to any type of tracking system 10.

The method also has the advantage of providing an evaluation even in very degraded situations in which it is no longer possible to compute a reconstructed trajectory.

It may also be noted that for data coming from the sensors, the method transfers the computational load to the learning. As a result, in the inference phase (controlling step), the computations can be performed in real time.

Moreover, learning does not involve computing the actual trajectory, which corresponds to a learning consuming less computational resources than a learning for the evaluation of ESASSP criteria.

The method is also robust with respect to input data insofar as the data coming from the set 12 of sensors are not necessarily regular and are supplied raw by the sensors of the set 12 of sensors.

The method which has just been described thus forms a method of local and unsupervised evaluation in real-time of the quality of service of aeronautical tracking.

According to the example shown in FIG. 4, the tracking system 10 is provided with the analysis module 20, the detection module 22 described hereinabove and an additional module which is a correction module 40.

The correction module 40 is a module for correcting anomalies in the observed space.

As such, the correction module 40 is apt to implement a step of identifying a possible cause of the presence of an anomaly by applying an identification function to the label or labels wherein the presence of an anomaly has been detected by the detection module 22.

Advantageously, the correction module is apt to test a corrective action associated with the identified cause. It is thereby possible to determine the most appropriate corrective action.

According to a particular example, the cause is a failure of one sensor or a plurality of sensors of the set 12 of sensors.

In such a case, the corrective action is to remove the data from the sensor which has the failure.

For such an example, a method of correcting anomalies in the observed space wherein the identification step is specific, can be implemented.

More specifically, the identification step comprises a generation operation, a detection operation and a deduction operation.

During the generation operation, the correction module generates new thumbnails.

New thumbnails correspond to the old trained thumbnails wherein the data coming from one or a plurality of sensors are removed.

Thereby, the new thumbnails correspond to the data accessible to a plurality of distinct subsets of distinct sensors.

According to one example, all the thumbnails corresponding to all the possible configurations can be generated.

During the detection operation, the correction module obtains from the detection module 22, the detection of the possible presence of anomalies in the generated thumbnails.

During the deduction operation, by comparing the results obtained during the detection operation, it is possible to deduce the sensor(s) causing the anomaly.

For example, if all the normality scores are increased in the absence of a sensor, the correction module deduces therefrom that said sensor is faulty and has to be discarded in order to improve the performance of the tracking system 10.

Alternatively or in addition, it is possible to modify the parameters of the analysis module 20.

The correction method thereby gives a recommendation for action aiming to resolve a detected anomaly.

In fact, the correction method serves to perform a causal analysis by determining the influence of a plurality of corrective actions on the normality score.

Thereby, the method makes it possible to discriminate fairly quickly between the actions which do not permit the restoration of the nominal situation and the actions which permit same.

In this sense, the correction method provides an unambiguous explanation of the cause of the presence of anomalies unlike a technique based on ESASSP criteria for which a plurality of different anomalies can lead to similar values for the evaluation of the performance.

Other variants of the methods which have just been described can be envisaged.

More particularly, it is possible that instead of a normality score, a performance score is obtained.

According to one example, the tracking system 10 further includes an evaluation module.

The evaluation module is apt to determine the performance of the tracking system 10 as a function of the number of anomalies and the frequency of anomalies detected by the detection module 22.

In other words, the evaluation module is used to calculate a performance score for the tracking system 10.

It is also possible to envisage replacing the detection unit 26 by an evaluation unit the role of which is to perform the performance calculation on the thumbnails.

The performance calculation can then be based on criteria independent of anomaly detection.

In such a case, the detection module becomes an evaluation module including the training unit 24 and the evaluation unit.

More generally, the evaluation module or the detection module 22 possibly supplemented by the correction module 40 forms a control module.

The control module is apt to control the observation by the tracking system 10 of the space corresponding to at least one thumbnail by applying a control function to all the data of the at least one thumbnail.

According to the example in FIG. 2, the control function is a function for detecting the possible presence of an anomaly in the label.

In the case of evaluation, the control function is a function for calculating the performance of the tracking system 10.

In each of the examples described, each module or sub-module is each produced in the form of a software or a software brick.

All modules are then produced in the form of a computer program, also called a computer program product, same being further apt to be recorded on a computer-readable medium (not shown). The computer-readable medium is e.g. a medium apt to store the electronic instructions and to be coupled to a bus of a computer system. As an example, the readable medium is an optical disk, a magneto-optical disk, a ROM, a RAM, any type of non-volatile memory (e.g. FLASH or NVRAM) or a magnetic card. A computer program containing software instructions is then stored on the readable medium, stored in a memory which can be executed by a processor.

In a variant (not shown), each module or sub-module is produced in the form of a programmable logic component, such as an FPGA (Field Programmable Gate Array), or an integrated circuit, such as an ASIC (Application Specific Integrated Circuit).

The invention relates to any technically possible combination of the embodiments described hereinabove.

1. A method of controlling the observation using a space tracking system, the method being implemented by a control module which is part of the tracking system, the control method including:
a step of thumbnail training, each thumbnail gathering a set of data accessible to the tracking system over a respective zone and a predefined time interval, the zones associated with each thumbnail covering the space observed by the tracking system and the set of predefined time intervals covering an observation time interval, the data including at least sensor data, and
a step of monitoring the observation using a space tracking system corresponding to at least one thumbnail by applying a control function to all the data of the at least one thumbnail.

2. The control method according to claim 1, wherein the set of data of each thumbnail comprises a reconstructed trajectory.

3. The control method according to claim 1, wherein the tracking system (10) outputs computed data, the set of data of each thumbnail comprising the computed data.

4. The control method according to claim 1, wherein the control function is a function of detecting the presence of an anomaly in the thumbnail.

5. The control method according to claim 4, wherein the anomaly detection function is obtained by a learning procedure, the learning procedure including:
learning a vector representation of thumbnails, and
obtaining an anomaly detection function from the learned vector representation.

6. The control method according to claim 5, wherein the learning step comprises the learning of a first sub-function from a labeled data set so as to obtain a first learned sub-function suitable for implementing a pretext task, the first learned sub-function being a neural network including a plurality of layers of neurons, the vector representation being the penultimate layer of the first learned sub-function

7. The control method according to claim 6, wherein the first sub-function is a residual neural network.

8. The control method according to claim 5, wherein the obtaining step is implemented using single-class support vector machines.

9. The control method according to claim 5, wherein the obtaining step is implemented using a neural network suitable for measuring the distance from a thumbnail to a set of thumbnails which are considered to be normal.

10. The control method according to claim 4, wherein the control method includes a step of identification of a possible cause of the presence of an anomaly by applying an identification function to the thumbnail or thumbnails wherein the presence of an anomaly was detected during the implementation step, the identification step being carried out by the anomaly correction module.

11. The control method according to claim 10, wherein the control method includes a test of a corrective action associated with the identified cause.

12. The control method according to claim 10, wherein the tracking system is apt to collect data coming from a plurality of sensors, the cause being a failure of a sensor and the corrective action being the removal of the data from the sensor presenting the failure.

13. The control method according to claim 12, wherein the identification step comprises:
the generation of thumbnails corresponding to data accessible to a plurality of subsets of distinct sensors,
the detection of anomalies in the thumbnails generated by the implementation of the detection method, and
the deduction of the sensor(s) causing the anomaly.

14. The control method according to claim 1, wherein the control function is a function for computing the performance of the tracking system.

15. The module for monitoring observation by a tracking system of a space, the control module being apt to:
train thumbnails, each thumbnail gathering a set of data accessible to the tracking system over a respective zone and a predefined time interval, the zones associated with each thumbnail covering the space observed by the tracking system (10) and the set of predefined time intervals covering an observation time interval, the data including at least sensor data, and
monitoring the observation using a space tracking system corresponding to at least one thumbnail by applying a control function to all the data of the at least one thumbnail.

16. A tracking system provided with a control module according to claim 15.
